(19) United States
(12) Patent Application Publication
(10) Pub. No.: US 2004/0139827 A1
(43) Pub. Date: Jul. 22, 2004

(54) Hand tool for applying torque to a spark plug threaded into a chevrolet V8 engine without removing the exhaust headers

(76) Inventor: Richard Michael Micklich, Chatsworth, CA (US)

Correspondence Address: STRADLING YOCCO CARLSON & RAUTH, SUITE 1600, 660 NEWPORT CENTER DRIVE, P.O. BOX 7680, NEWPORT BEACH, CA, 92660, US

(21) Appl. No.: 10/755,180

(22) Filed: Jan. 8, 2004

Related U.S. Application Data
(63) Continuation-in-part of application No. 09/579,165, filed on May 25, 2000, now abandoned.

(51) Int. Cl. B25B 13/00

(52) U.S. Cl. 81/124.3; 81/125.1

(57) ABSTRACT

A hand tool for accessing and stably applying torque to tighten or loosen one or more spark plugs from Chevy small-block, big-block, and LS-1 V8 engines without removing the adjacent exhaust headers is disclosed. The hand tool is provided with a tubular pass through socket having both ends open and a length shorter than the length of the spark plug extending from the engine cylinder head into which it is threaded, but longer than the extending base of the spark plug. The tubular pass through socket has an internal surface dimensioned to receive the base of the spark plug in secure engagement to prevent damage to the porcelain insulator of the spark plug as the wrench is fitted to the spark plug and when torque is applied, and a generally radially extending handle at a uniplanar angle relative to the longitudinal axis of the tubular pass through socket ranging from 50° to 130° and of sufficient length to apply torque ranging from approximately 10 lbs/ft to 30 lbs/ft.

### FIELD OF THE INVENTION

This application is a continuation-in-part of prior U.S. patent application Ser. No. 09/579,165 filed May 25, 2000, now pending. The present invention generally relates to the field of hand tools for motor vehicle engines. More particularly, the present invention relates to wrenches for applying torque to one or more spark plugs in a Chevrolet V8 engine mounted in a vehicle engine compartment.

### BACKGROUND OF THE INVENTION

The V8 internal combustion engine has become synonymous with high performance and the American “Hot Rod” culture. V8 engines can be found in a wide variety of motor vehicles including cars, trucks, boats, and even in 2-wheeled motorcycles and 3-wheeled trikes. Today, V8 engines are available from multiple domestic and foreign manufacturers in a variety of sizes, cylinder head configurations, states of tune, and specific power outputs. These engines can range from relatively low power output, small displacement flathead engines, like those originally developed by Ford Motor Company in the 1920's, to high performance, large displacement, overhead valve engines developed in the United States during the 1950's and 1960's, to modern, high-revving, overhead cam and multi-valve designs produced by both United States and foreign manufacturers. Over the years specific power outputs for such engines have risen from under 100 horsepower to well over 60° horsepower.

In spite of the multiplicity of engines available in the modern motor vehicle marketplace, one of the most popular V8 engines ever built is the “small-block” V8 which was introduced into the United States by the Chevrolet division of General Motors in 1955. Originally produced with an internal volume or “displacement” of 265 cubic inches and later with 283 cubic inches, the Chevy small-block V8 developed a strong and well earned reputation for reliability and ease of modification. In some cases small-block Chevy V8s have been “bored and stroked” to increase their displacement from the original 265 or 283 cubic inches to over 400 cubic inches without sacrificing reliability.

Today, over 18,000,000 small-block Chevy V8s remain in operation and brand new “crate” small-block Chevy V8 motors are readily available to the engine and hot rod hobbyist at reasonable prices. Equally popular with today's motor vehicle enthusiasts are the later offshoots of the small-block Chevy V8 including the Chevy “big-block”, with an original displacement of 396 cubic inches, and the more modern “LS-1” engines made available in Chevrolet Camaros. As with the small-block V8, the big-block and LS-1 V8 engines respond well to modification and “hot rodding” where ignition, intake, and exhaust systems are modified or replaced with aftermarket performance parts to improve efficiency, power output, and aesthetics.

However, one issue that owners of these engines have lived with since the first small-block V8s appeared over 50 years ago is the fact that it can take over 2½ hours for an experienced mechanic to remove or replace even one of the eight engine spark plugs. Unlike the early flathead V8 motors and the more recent dual-overhead cam V8 motors with their spark plugs centrally located and easily accessible on top of the engine cylinder heads, because of the pushrod overhead valve design of the Chevy V8 cylinder heads, the spark plugs are located in pockets or recesses near the lower outside edges of the cylinder heads. This is not a problem during the initial manufacture or assembly of the engines because nothing gets in the way of positioning a spark plug wrench to apply torque to the individual spark plugs. However, once the exhaust manifolds are installed, one per each cylinder head of the V8 engine, the spark plugs are frustratingly visible, yet impossible to reach with known spark plug wrenches or other tools. Once installed, the engine exhaust manifolds or “headers” shroud or occlude the spark plugs installed in the recesses on the outside edges of the cylinder heads.

This lack of accessibility can be exacerbated with high performance aftermarket headers. Aftermarket headers typically have larger diameter tubing with smoother, larger radius bends than the stock or OEM (“Original Equipment Manufacturer”) headers in order to improve the flow of exhaust gases exiting through the exhaust manifolds. Once installed in place of the OEM manifolds, these larger diameter header tubes further occlude the spark plugs to the point that it is completely impossible to position a spark plug wrench onto the spark plugs; let alone to apply torque to the spark plugs in order to tighten or loosen the spark plugs. The only solution is to remove the exhaust headers first to provide unimpeded access. As a result, the simple 10 or 15 minute job of removing and replacing eight spark plugs in a Chevy V8 must be both preceded and followed by the one hour or longer jobs of removing and then reinstalling the exhaust manifolds. This job can become even more complex and time consuming with the engine installed in a vehicle's engine compartment. Depending on the particular vehicle, the walls of the engine compartment can further restrict access to the spark plugs or to the overlying exhaust manifolds. It is not unheard of in some vehicles to have to remove the entire engine from the vehicle engine compartment as well as having to remove the exhaust system just to replace a single worn out or non-functioning spark plug.

It is very difficult to remove or replace the spark plugs from Chevy V8 small-block, big-block and LS-1 engines which have installed OEM or aftermarket headers because conventional spark plugs sockets or wrenches are designed to axially align with and slip completely over each of the respective spark plugs extending from the engine cylinder heads. This is because conventional internal combustion engine spark plugs are manufactured as one-piece articles having a threaded metal base approximately ¾ inch long and 5/8 inch, 11/16 inch, or 13/16 inch in diameter with hexagonal facets for engaging a correspondingly dimensioned socket of a spark plug wrench or socket and wrench combination. Axially extending from this spark plug metal base an additional 1 inch to 1½ inch is a relatively fragile, high temperature porcelain insulator which surrounds a conducting metal center electrode of the spark plug. It is the lower end of this center electrode which projects through the metal base of the spark plug and into the combustion chamber of the engine cylinder into which the spark plug is threaded and installed in order to deliver the spark which ignites the fuel/air mixture when the engine is running.

Because the hexagonal base of each of the eight spark plugs in a Chevy V8 is located adjacent to the surface of the cylinder head into which it is threaded and installed, the spark plug wrench must be long enough to slip over the entire length of the spark plug extending from the engine cylinder head so that the internal facets of the wrench can securely engage the facets at the base of the spark plug in order to apply torque. If the engagement of the wrench is not secure, attempting to turn the wrench to apply a loosening or tightening torque to the spark plug can cause the wrench to shift relative to the extending longitudinal axis of the spark plug. This misalignment can crack or fracture the extending porcelain insulator. Once this happens the spark plug will not function properly and must be replaced with a non-broken spark plug.

More specifically, a conventional spark plug wrench for use on an American V8 engine is formed with a high-strength socket or metal tube approximately 3 inches long with an open, 6-point (hexagonal) or 12-point (duodecimal) faceted internal base ranging in diameter from 5/8 inch to 13/16 inch, depending on the diameter of the hexagonal spark plug base it is intended to fit. The wrench socket is closed at the top of the tube and provided with a 3/8 inch square socket so that a 3/8 inch drive handle or ratchet can be installed into the top of the spark plug wrench socket. The handle or ratchet provides sufficient leverage about the axis of the socket and spark plug received therein to allow a mechanic or operator to apply the proper amount of torque to tighten or loosen the spark plug. For example, the intended torque for a Chevy V8 spark plug will range from about 10 lbs/ft to 35 lbs/ft; with an installed torque of around 15 lbs/ft. The higher torque levels occasional may be necessary to “break loose” or untighten a particularly resistant spark plug that has developed an overly high degree of tightening torque due to its having been installed and run in an engine for multiple heating and cooling cycles. Known ratchets and drive handles used for these purposes generally are about 7 inches to 8 inches long to enable a mechanic or operator to apply sufficient torque easily.

In Chevy V8s, particularly small-block, big-block and LS-1 push rod V8 engines, the spark plugs are located in such inaccessible areas that the use of common or known tools or any combination of such known tools is simply not workable without first removing the exhaust headers and/or removing the engine from the engine compartment. The occluding headers prevent a normal spark plug wrench from being positioned and aligned where it can slide over the length of the spark plug and engage the spark plug hexagonal base. This is particular true if a ratchet or drive handle is installed on top of the wrench socket, thereby increasing its overall length. In such a dimensionally restrictive environment attempting to lever or force the wrench or socket and handle combination over the spark plug at an angle can fracture the insulator, making the spark plug useless.

Similarly, while it may be possible in some cases to maneuver a relatively narrow, approximately ½ inch thick conventional box end wrench underneath the occluding headers and over the extending end of the porcelain spark plug insulator, the recessed location of the spark plugs in Chevrolet V8 engines makes it impossible to securely engage the box end wrench with the hexagonal base of the spark plug recessed into the side of the cylinder head. Thus, even narrow wrenches are ineffective at tightening or loosening spark plugs in Chevy V8 engines. Moreover, even if a narrow box end wrench is bent so that it can be engaged with the hexagonal spark plug base, the overlying exhaust header will make it impossible to turn the wrench a sufficient degree of rotation to apply an effective amount of torque to the spark plug.

In sum, it takes an inordinate amount of time to remove the spark plugs from a Chevrolet V8 engine with the headers installed due to the cramped position of the spark plugs located underneath and behind the headers. This is because it is impossible to axially align the 2½ to 3 inch long spark plug socket so that it can be slipped over the extending spark plug. Trying to lever or force a conventional, prior art spark plug wrench over the spark plug will only fracture the porcelain insulator. Other wrenches known in the art, such as box end wrenches or even slotted wrenches have the same problem of non-secure engagement with the hexagonal base of the spark plug and are equally ineffective. The spark plugs are simply too inaccessible to reach without removing the adjacent exhaust header. The present invention addresses these problems and is a perfect size and configuration to remove the spark plugs from Chevy small-block, big-block, and LS-1 V8 engines without removing the OEM or aftermarket headers or removing the engine itself from the engine compartment.

The following sixteen (16) prior art patents were found to be pertinent to the field of the present invention:

1. U.S. Pat. No. 1,209,658 issued to Baltzley on Dec. 26, 1916 for “Tool” (hereafter the “Baltzley patent”);

2. U.S. Pat. No. 1,417,725 issued to Fullenwideron May 30, 1922 for “Tool Kit” (hereafter the “Fullenwider patent”);

3. U.S. Pat. No. 1,469,662 issued to Leopold on Oct. 2, 1923 for “Socket Wrench” (hereafter the “Leopold patent”);

4. U.S. Pat. No. 1,509,258 issued to Reiser on Sep. 23, 1924 for “Duplex Wrench” (hereafter the “Reiser patent”);

5. U.S. Pat. No. 1,567,877 issued to Tuttle on Dec. 29, 1925 for “Tool Construction” (hereafter the “Tuttle patent”);

6. U.S. Pat. No. 1,734,270 issued to Olson on Nov. 5, 1929 for “Spark Plug Wrench” (hereafter the “Olson patent”);

7. U.S. Pat. No. 1,832,185 issued to Cochrane on Nov. 17, 1931 for “Wrench” (hereafter the “Cochrane patent”);

8. U.S. Pat. No. 2,094,584 issued to Cox on Oct. 5, 1937 for “Limited Strain Wrench” (hereafter the “Cox patent”);

9. U.S. Pat. No. 3,532,012 issued to Pryor on Oct. 6, 1970 for “Chuck Wrench” (hereafter the “Pryor patent”);

10. U.S. Pat. No. 3,838,614 issued to O'Donnell on Oct. 1, 1974 for “Reciprocating Engine Barring Tool” (hereafter the “O'Donnell patent”);

11. U.S. Pat. No. 4,840,094 issued to Macor on Jun. 20, 1989 for “Multiple Socket And Multiple Socket Wrench” (hereafter the “Macor patent”);

12. U.S. Pat. No. 5,230,263 issued to Kwaka on Jul. 27, 1993 for “Wrench For Use On Threaded Parts That Are Not Easily Accessible” (hereafter the “Kwaka patent”);

13. U.S. Pat. No. 5,913,954 issued to Arnold et al. on Jun. 22, 1999 for “Pawl For A Low Profile Wrench” (hereafter the “Arnold patent”);

14. U.S. Pat. No. 5,964,129 issued to Shiao on Oct. 12, 1999 for “Ratchet Wrench With A Direction Control Ratchet Member” (hereafter the “Shiao patent”); and

15. United States Statutory Invention Registration No. H1689 issued to Foucher on Nov. 4, 1997 for “Wrench Head For Applying High Torque In Limited Space And method Of Construction” (hereafter the “Foucher Reference”).

16. French Patent No. 961,607 to Carle and published May 16, 1950 for “A Screw Key Device” (hereafter the “Carle Reference”).

The Baltzley patent discloses a tool which includes a rotatable member and a nut-receiving member.

The Fullenwider patent discloses a tool kit consisting of a plurality of simple implements adapted through various combinations to form tools most commonly used in emergency repair work on automobiles.

The Leopold patent discloses a socket wrench which includes a handle pivotably connected within the open end of the socket.

The Reiser patent discloses a duplex wrench which includes a holding unit and a turnable unit.

The Tuttle patent discloses a tool construction.

The Olson patent discloses a spark plug wrench. It includes two heads wherein one head is rotatably mounted on the other head. Each head has a projecting handle which is independently rotatable.

The Cochrane patent discloses a wrench which includes a handle and a head receiving end, wherein the head receiving end is perpendicular to the handle.

The Cox patent discloses a limited strain wrench.

The Pryor patent discloses a chuck wrench.

The O'Donnell patent discloses a reciprocating engine barring tool. It includes a multi-position, multi-angular extension handle, tapered ratchet handle, ratchet head assembly, double tooth dog holding action for clockwise and counterclockwise operation by a single unaided person.

The Macor patent discloses a multiple socket device which has four different socket sizes located about a single axis. It includes inner and outer members, where the inner member is slidably fitted into the outer member.

The Kwaka patent discloses a wrench for use on threaded parts that are not easily accessible. The tool is used for turning threaded machine nuts and bolts.

The Arnold patent discloses a pawl for a low profile wrench.

The Shiao patent discloses a ratchet wrench with a direction control ratchet member. It includes a handle which has an open end and a box end. A circular adaptor is rotatably secured within the box end for engaging a nut or the like. The ratchet member engages with the circular adaptor for rotating the circular adaptor.

The Foucher Reference discloses a wrench head for applying high torque in limited space and a method of construction. The wrench head includes a bar which extends from a square socket to a wrench head. The wrench head has a pair of arms or jaws which extend from proximal ends of the arms joined with the base structure to individual distal ends of the arms. Arms are disposed in spaced relation and conform to a bolt head for radially opposite engagement of the element.

The Carle Reference discloses a combination wrench having a short tubular socket wrench on one end and a closed polygonal wrench on the other end. The ends of the wrench are oriented at an obtuse angel slightly in excess of 90° relative to the direction of the axial handle of the wrench.

Accordingly, none of these references discloses or suggests the specialized hand tool of the present invention that can be used to remove or replace one or more spark plugs from Chevy small-block, big-block, or LS-1 V8 engines without the need to remove the exhaust headers or the engine from a vehicle engine compartment where the hand tool can be used in a cramped and occluded location where the spark plugs are located.

### SUMMARY OF THE INVENTION

In a broad aspect the present invention provides a new hand tool for removing and installing spark plugs in Chevrolet V8 engines such as the Chevy small-block, big-block, and LS-1 V8 engines that are so popular with American motor vehicle hobbyists and enthusiasts. Removing or installing a spark plug in most engines is normally a simple procedure involving placing an appropriately sized spark plug wrench over the spark plug and turning the wrench to apply torque to loosen or tighten the spark plug in a threaded hole in the engine's cylinder head. This “simple” process is frustratingly complicated in the subject Chevy V8 engines because these engines' exhaust systems make it impossible for even a skilled mechanic to access the spark plugs with a conventional wrench; let alone to apply torque through the wrench without breaking the spark plugs. The normal method for dealing with this difficulty is for the engine mechanic to remove the exhaust headers from the engine first in order to provide access to the spark plugs so a wrench can be applied. Removing and installing a Chevy V8 exhaust system is a multi-hour job, whereas removing and replacing the now exposed spark plugs takes only minutes.

Accordingly, it is a primary object of the present invention to provide a hand tool for accessing and stably applying torque to one or more spark plugs in these popular Chevy V8 engines without removing the adjacent exhaust headers or other components associated with these engines in a vehicle engine compartment. These and additional objects are achieved by the hand tool of the present invention which provides a tubular pass through socket having both of its opposing ends open and a length that is shorter than the axial or longitudinal length of the spark plug extending from the engine cylinder head and greater than the length of the spark plug's hexagonal base alone. The extending spark plug length is a combination of the length of the metal hexagonal base of the spark plug threaded into the engine cylinder head and the length of the spark plug porcelain insulator longitudinally extending outwardly therefrom, and is on the order of 2 to 3 inches. Thus, in accordance with the teachings of the present invention, the length of the tubular pass through socket is generally greater than 5/8 inch and less than 2 inches and will generally be on the order of 1 to 1½ inches, plus or minus 1/4 inch. Once securely positioned on the spark plug, the outer end of the spark plug will extend through the open outer end of the tubular pass through socket.

At least one of the two opposing open ends of the tubular pass through socket is provided with an internal surface that is sized and shaped to longitudinally or axially align with and to securely engage with either the six facets of the spark plug hexagonal base, or at least with the six apices of the hexagonal base. Thus, this internal surface can be shaped either hexagonally with six sides and apices, or duodecimally with twelve points or apices. It is within the scope and teachings of the present invention for this internal surface to be provided adjacent to either or both open ends of the tubular pass through socket. Further, the internal surface of the tubular pass through socket of the present invention will have a diameter corresponding to the diameter of the spark plug hexagonal base over which it is intended to fit. Exemplary diameters include 5/8 inch, 11/16 inch, and 13/16 inch, though other diameters are contemplated as being within the scope of the present invention. Those skilled in the art will appreciate that a 5/8 inch diameter is a very common spark plug size for Chevy V8 engine spark plugs.

The hand tool of the present invention further includes a handle which radially extends from the side of the tubular pass through socket and is fixedly engaged therewith in order to allow the mechanic or tool operator to apply leverage about the longitudinal axis of the spark plug securely engaged within the tubular pass through socket without increasing the effective length of the tubular pass through socket. In accordance with the teachings of the present invention, the handle forms a uniplanar angle ranging from 50° to 130° relative to the longitudinal axis of the spark plug and tubular pass through socket. This handle can be rigidly attached to the tubular pass through socket at a fixed angle within this range, or it can be pivotally attached to the tubular pass through socket so that it is capable of stably forming a desired uniplanar angle within this range. In accordance with the teachings of the present invention the pivotal attachment can be accomplished with any appropriate pivoting mechanism known in the art.

For example, one embodiment of the present invention particularly well suited for use in connection with a Chevy small-block V8 has a rigidly attached handle forming a uniplanar angle ranging from 120° to 125°. An alternative embodiment of the present invention that is well suited for use with a Chevy big-block V8 has a rigidly attached handle forming an angle ranging from 55° to 60° relative to the axis of the spark plug or tubular pass through socket. An additional alternative embodiment of the present invention includes a tubular pass through socket having spark plug receiving and engaging internal surfaces at both of its open ends and a handle radially extending from the side of the tubular pass through socket at a position generally equidistant from each of the open ends and forming a uniplanar angle that is plus or minus 30° to 35° from perpendicular to the longitudinal axis of the spark plug or tubular pass through socket. This alternative embodiment can be used with either a Chevy small-block or big-block V8 simply by inverting the tubular pass through socket relative to the extending spark plug in order to produce the appropriate uniplanar angle providing clear access to mount the tool on the spark plug and to turn the handle to apply torque to the securely engaged spark plug.

Further, by utilizing the teachings of the present invention and providing the hand tool with a radially extending handle having a pivot disposed adjacent to the tubular pass through socket it is possible to produce appropriate uniplanar angles with the handle that provide clear access to mount the tool on the spark plug and to turn the handle to apply torque on the securely engaged spark plug in Chevy small-block, big-block, and LS-1 V8 engines. Those skilled in the art will appreciate that the LS-1 hand tool of the present invention can be formed with a rigid handle as well within the scope and teaching of the present invention.

Whether rigidly attached or pivotally attached, the handle of the present invention is of sufficient length to allow a mechanic or operator of the hand tool to apply positive or negative torque about the longitudinal axis of a spark plug ranging from approximately 10 lbs/ft to 30 lbs/ft, or more. This will enable the hand tool to apply appropriate torque to tighten a spark plug to the proper torque setting of approximately 15 lbs/ft as well as to provide even greater torque if necessary to loosen a particularly tight spark plug without being so long that it will interfere with other elements of the vehicle engine compartment that may restrict its movement.

It is also within the scope of the present invention to provide the hand tool with a ratcheting mechanism disposed between the tubular pass through socket and the handle to facilitate the rotational manipulation of the hand tool following its alignment and secure engagement with the base of the spark plug. Further, it is within the scope of the present invention to provide the tubular pass through socket with an internal shoulder to engage the top of the base of the spark plug.

An additional alternative embodiment of the present invention is a specialized hand tool which is a combination box end and pass through socket wrench used to remove or replace one or more spark plugs from Chevy small-block, big-block, or LS-1 V8 engines without removing the adjacent exhaust headers. This combination box and socket wrench embodiment of the present invention is a perfect size and configuration for this purpose and also includes an additional box end wrench for use in connection with other fasteners that can be found in and around a Chevy V8 engine or engine compartment in a motor vehicle.

This alternative embodiment of the present invention combination box and socket wrench can include a inch, 11/16 inch, or 13/16 inch tubular pass through socket end portion and a box end portion that can be a variety of common threaded fastener sizes. As with the previously discussed embodiments of the present invention, the tubular pass through socket end portion fits completely around the spark plug with the spark plug extending through the open front end of the socket to the rear end so that with the hand tool, it is easy to turn the spark plug to apply torque and tighten or loosen the spark plug to disconnect it from the engine and remove it or replace it.

It is contemplated as being within the scope of the present invention to form the hand tool from metal such as steel, aluminum, or metal alloys, as well as from composites, or other materials having sufficient strength to handle the mechanical and shearing loads expected to be experienced when the hand tool is in use. This can be accomplished through a wide variety of known manufacturing techniques including forging, casting, and machining. Similarly, the hand tool of the present invention should be formed of one or more materials having sufficient temperature resistance to withstand contact with a hot spark plug removed from a recently running V8 engine.

Further novel features and other objects of the present invention will become apparent to those skilled in the art from the following Detailed Description, and the appended claims, taken in conjunction with the Drawings, which first will be described briefly.

### BRIEF DESCRIPTION OF THE DRAWINGS

Referring particularly to the drawings for the purpose of illustration only and not for limitation, there is illustrated:

FIG. 1 is a perspective view of an exemplary embodiment of a hand tool illustrating the principles of the present invention and its tubular pass through socket;

FIG. 2 is a side elevational view of the present invention hand tool shown in FIG. 1 illustrating an exemplary uniplanar angle;

FIG. 3 is a longitudinal cross-sectional view of the present invention hand tool shown in FIG. 2;

FIG. 4 is a perspective view of an alternative embodiment of the present invention hand tool illustrating an alternative uniplanar angle relative to the longitudinal axis of its tubular pass through socket;

FIG. 5 is a side elevational view of an additional alternative embodiment of the present invention hand tool illustrating a tubular pass through socket having dual spark plug receiving and engaging open ends;

FIG. 6 is a side elevational view of an additional alternative embodiment of the present invention hand tool illustrating a pivoting handle extending from a tubular pass through socket;

FIG. 7 is a perspective view of an alternative embodiment of the present invention hand tool illustrating its combined box end and tubular pass through socket end construction;

FIG. 8 is a side elevational view of the present invention hand tool shown in FIG. 7;

FIG. 9 is a longitudinal cross-sectional view of the present invention hand tool shown in FIG. 8; and

FIG. 10 is a longitudinal cross-sectional view of an additional alternative embodiment of the present invention hand tool illustrating a shoulder within the tubular pass through socket thereof.

### DETAILED DESCRIPTION OF THE INVENTION

Although specific embodiments of the present invention will now be described in detail with reference to the drawings, it should be understood by those skilled in the art that such embodiments are by way of example only and not of limitation. They are merely illustrative of but a small number of the many possible embodiments of the present invention. Various changes, modifications, and adaptations are available to one skilled in the art to which the present invention pertains and are within the scope of the present invention as will be discussed in detail below and as further defined in the appended claims.

For almost 50 years, beginning with the Chevrolet small-block V8 engine and continuing with the later developed Chevrolet big-block and LS-1 V8 engines, motor vehicle enthusiasts and professional mechanics have had to deal with the frustrating problem of changing spark plugs on these engines that are impossible to reach with conventional tools. The only practical solution to this ongoing problem has been the laborious and time consuming process of first removing the exhaust manifolds or “headers” from these engines in order to provide direct access to the spark plugs.

With the headers removed a spark plug wrench or spark plug socket and wrench combination can be positioned over each of the individual spark plugs allowing the mechanic or enthusiast to apply sufficient twisting force or “torque” about the longitudinal axis the spark plug to loosen and unscrew or remove the spark plug extending from the cylinder head into which it is threaded. Similarly, once the headers are removed it is possible to reinstall the spark plugs or to install new spark plugs as needed. Removing and install the eight, now accessible spark plugs in a V8 engine is a simple process that takes on the order of ten minutes. However, the need to first remove and then reinstall the exhaust headers adds hours to what would be a relatively simple task if the spark plugs were accessible in the first place. The present invention provides a solution to this long felt need by supplying multiple exemplary embodiments of a hand tool that is uniquely suited to this problem and enables the spark plugs to be removed from these Chevrolet V8 engines without removing the exhaust headers or removing the engine from the engine compartment.

As a preliminary matter, to assist in the understanding of the present invention, the context of a V8 engine and its spark plugs will be described briefly. As those skilled in the art will appreciate, a V8 engine has its eight cylinders arranged in linearly aligned groups of four parallel cylinders, each cylinder bank or group of four cylinders is angled at 90° with respect to the other, forming a V with four cylinders on each side. Each cylinder bank of four cylinders is capped with a cylinder head into which four of the spark plugs are threaded. Thus, a V8 engine utilizes a total of eight spark plugs, each of which is threaded into a correspondingly sized, threaded hole, appropriately positioned in the cylinder head on top of each cylinder. In the subject Chevrolet V8 engines the spark plugs are position in recesses on the lower outside edges near the base of each cylinder head and close to the exhaust port for each cylinder in the respective cylinder bank. An exhaust manifold or header is securely attached to the four exhaust ports on each cylinder head and because of this close positioning, occludes the spark plugs.

Each of the eight spark plugs is identical to the other and has a hexagonal base typically sized to have a diameter of either ⅝, 11/16, or 13/16 of an inch, depending on its manufacture. It is this hexagonal base that engages a correspondingly sized spark plug socket or wrench so the spark plug can be turned with sufficient twisting force or “torque” about its longitudinal axis to tighten or loosen the spark plug during installation or removal. The hexagonal base also includes an axially aligned, downwardly extending threaded portion that is screwed into a correspondingly sized and threaded hole in the engine cylinder head to install the spark plug. Axially extending upwardly from the hexagonal base is a porcelain insulator surrounding a conducting metal core. The conducting metal core extends outwardly from the top of the porcelain insulator to allow a spark plug wire to be attached in order to deliver an electric spark through the spark plug to the interior of the cylinder to ignite a fuel air mix producing internal combustion. With this understanding, the present invention now will be discussed in detail.

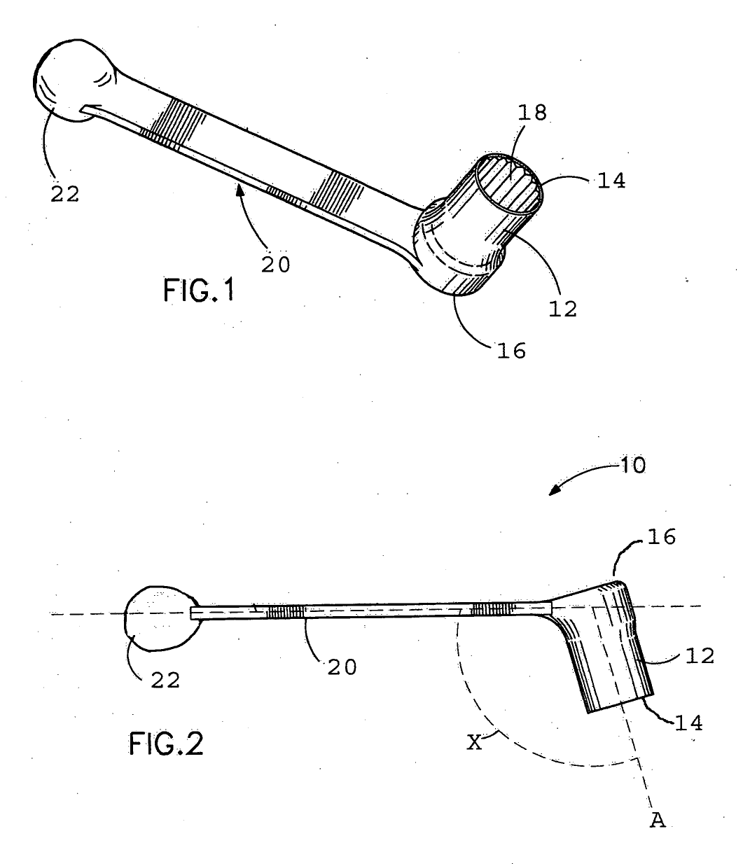

Referring more particularly to the drawings, FIGS. 1, 2, and 3 illustrate an exemplary embodiment of the hand tool of the present invention generally designated by reference numeral 10. For purposes of illustration only and not for purposes of limitation, exemplary embodiment 10 will be discussed in the context of a Chevrolet small-block V8 engine. However, those skilled in the art will appreciate that the present invention is equally applicable to Chevrolet big-block and LS-1 V8 engines. Hand tool 10 includes a tubular pass through socket 12 having both of its ends 14 and 16 open to allow a longitudinally or axially aligned spark plug (not shown) to pass through open ends 14 and 16 into the cylindrical space defined by the interior of tubular pass through socket 12 as socket 12 is slipped into position over the spark plug. Those skilled in the art also will appreciate that when hand tool 10 is positioned over a spark plug that is threaded into a Chevrolet V8 engine, open end 14 will be passed over the extending top of the spark plug first and then advanced axially downward as tubular pass through socket 12 is axially aligned with the longitudinal axis of the spark plug to a position stably surrounding and securely engaging the hexagonal base of the spark plug. Once so engaged, the top of the extending spark plug porcelain insulator will project out through open end 16.

In accordance with the teachings of the present invention, tubular pass through socket 12 has a length L that is shorter than the length of the spark plug longitudinally extending outwardly from the V8 engine cylinder head into which the spark plug is threaded. As those skilled in the art will appreciate, this extending spark plug length is a combination of the length of the spark plug's porcelain insulator longitudinally or axially extending from the hexagonal base of the spark plug and the length of the hexagonal base itself, which is threaded into a correspondingly sized hole in the engine's cylinder head. Additionally, length L of tubular pass through socket 12 is greater than the length of the spark plug hexagonal base alone. Accordingly, tubular pass through socket 12 has a length that is greater than the length of the extending hexagonal base of the spark plug and shorter than the combined length of the porcelain insulator and the hexagonal base longitudinally extending outwardly from the V8 engine cylinder head. Thus, in accordance with the teachings of the present invention, the length of tubular pass through socket 12 is generally greater than 5/8 inch and less than 2 inches and will generally be on the order of 1 to 1½ inches, plus or minus ¼ inch.

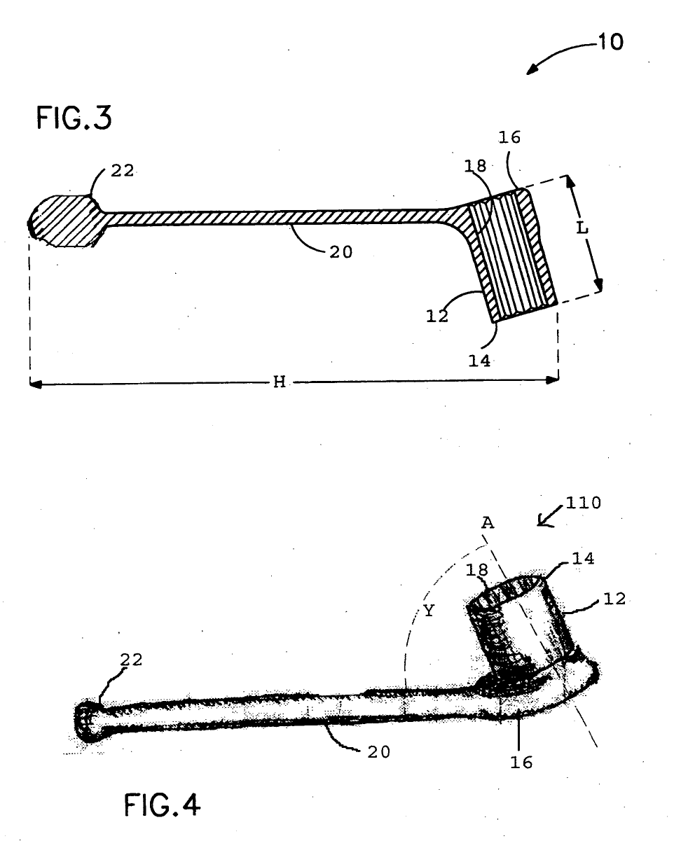

With particular reference to FIGS. 1 and 3, tubular pass through socket 12 of hand tool 10 is provided with an internal surface 18 which is illustrated as being disposed adjacent to open end 14. In the exemplary embodiment illustrated in FIGS. 1 and 3 internal surface 18 extends along the entire length of tubular pass through socket 12 completely between open ends 14 and 16. It should be emphasized that internal surface 18 need not completely extend between orto the respective open ends 14 and 16. Rather, because internal surface 18 is constructed to have appropriate dimensions to receive and engage the hexagonal base of a spark plug positioned within tubular pass through socket 12, internal surface 18 need only extend with sufficient length to securely engage at least the apices or the facets of the spark plug hexagonal base in secure, stable axial alignment. This exemplary construction enables the operator of hand tool 10 to stably apply torque about the longitudinal axis of the spark plug without hand tool 10 slipping or shifting out of axial alignment and thus prevents hand tool 10 from cracking the porcelain insulator of the spark plug.

In order to allow internal surface 18 to engage at least the six apices of the spark plug base, surface 18 is provided with at least six, and preferably twelve facets or grooves. For example, internal surface 18 as illustrated in FIG. 3 is provided with a twelve-point or duodecimal configuration rather than a six-point or hexagonal configuration. This duodecimal configuration is desirable because it provides an added degree of maneuverability to the use of hand tool 10. This is because hand tool 10 need not be turned as far, only about 30°, before it can be repositioned and reengaged with the hexagonal base of the spark plug to apply additional torque. In contrast, a hexagonal internal surface 18 may need to be turned twice as far before it can be repositioned and reengaged with the next facet of the hexagonal base. This is advantageous in circumstances where the ability to turn hand tool 10 is restricted by the confines of a tight vehicle engine compartment while the headers remain installed on the subject V8 engine.

The diameter of internal surface 18 of tubular pass through socket 12 is appropriate to securely engage at least the apices of the hexagonal base of the spark plug. Exemplary diameters include 5/8 inch, 11/16 inch, and 13/16 inch, though other diameters are contemplated as being within the scope of the present invention. Those skilled in the art will appreciate that a 5/8 inch diameter is a very common spark plug size for Chevy V8 engine spark plugs.

As shown in FIGS. 1, 2, and 3, hand tool 10 includes a handle 20 which radially extends from the side of tubular socket 12 at one end to form handle end 22 at the other end. Handle 20 is securely fixed to tubular pass through socket 12 so that as handle 20 is pushed or pulled by a mechanic or tool operator it will apply a twisting force or torque about the longitudinal axis A of tubular pass through socket 12. When tubular pass through socket 12 is securely engaged with the hexagonal base of a spark plug (not shown) received therein, longitudinal axis A will align with the longitudinal axis of the spark plug. Thus, torque applied to handle 20 and tubular pass through socket 12 will be stably applied about the longitudinal axis of the spark plug.

Again referring to FIG. 2, handle 20 is formed to be of sufficient length to allow the average operator to apply a torque about axis A of tubular pass through socket 12 ranging from approximately 10 lbs/ft to 30 lbs/ft, or more. For most practical purposes this length will range from five to seven inches, though longer or shorter lengths are contemplated as being within the scope of the present invention. Nonetheless, it should be appreciated by those skilled in the art that forming a hand tool 10 in accordance with the teachings of the present invention having a handle 20 much longer than seven inches may cause handle end 22 to interfere with internal structures of the vehicle engine compartment or with the engine headers, restricting its operability. Conversely, forming handle 20 much shorter than five inches may make it difficult to apply sufficient torque without undue effort.

In FIGS. 1 through 3, handle 20 is shown as being rigidly attached to tubular pass through socket 12. This form of construction simplifies the manufacture of hand tool 10 as this exemplary embodiment of the present invention can be a one-piece construction. Thus, hand tool 10 with a rigidly attached handle 20 can be cast, forged, milled from billet, or manufactured using a wide variety of techniques. However, as will be discussed in further detail with reference to FIG. 6, handle 20 may also be fixedly attached to tubular pass through socket 12 with a pivot. In this alternative embodiment of the present invention illustrated in FIG. 6 it is still possible to manufacture the components of hand tool 10 through conventional manufacturing techniques including casting, forging, milling, or other techniques known in the art.

Further, it is also contemplated as being within the scope of the present invention to form hand tool 10 with a ratcheting mechanism operationally disposed between tubular pass through socket 12 and handle 20. Many different ratcheting mechanisms are known in the art that are suitable for this purpose. Most will utilize a pawl and tooth mechanism that will allow handle 20 to be forcefully pushed in one direction to rotate tubular pass through socket 12 and then retracted in the other direction where the pawl will disengage the locking teeth.

An additional aspect of the present invention that contributes to the operability of hand tool 10 and facilitates its ability to access a spark plug to obtain secure engagement with its hexagonal base and to apply torque about its longitudinal axis without removing the exhaust headers is handle 20 forming a uniplanar angle relative to axis A of tubular pass through socket 12. It is contemplated as being within the scope of the present invention to form this angle ranging from 50° to 130° relative to axis A. Put in other terms, this uniplanar angle can be considered to range from plus or minus 30° to 35° from perpendicular to axis A. For example, with reference to FIG. 2, an exemplary uniplanar angle formed between handle 20 and axis A of tubular pass through socket 12 that is appropriate for the use of hand tool 10 with a Chevrolet small-block V8 engine is identified as angle X. In this exemplary embodiment of the present invention angle X ranges from approximately 120° to 125°. An exemplary angle within the scope and teachings of the present invention is 122°.

This unique construction of hand tool 10 enables an operator or mechanic to position hand tool 10 with axis A at an initial angle relative to the longitudinal axis of a spark plug extending outwardly from the cylinder head of a Chevrolet V8 engine in an engine compartment without being blocked by the adjacent exhaust manifold occluding the underlying target spark plug. Then, due to this unique construction of hand tool 10, the operator is able to slide open end 14 of tubular pass through socket 12 down along the extending porcelain insulator of the spark plug and to align axis A with the longitudinal axis of the spark plug until internal surface 18 adjacent to open end 14 receives and engages the apices of the spark plug hexagonal base. Those skilled in the art will appreciate that unlike conventional spark plug sockets and wrenches having closed upper ends that completely enclose a spark plug contained therein, the spark plug so received by the hand tool of the present invention extends completely through tubular pass through socket 12 so that at least the outer tip of the spark plug extends out through open end 16.

During this positioning process and again after hand tool 10 is aligned with and engaging the hexagonal spark plug base, uniplanar angle X prevents handle 20 from engaging the adjacent and at least partially overlying exhaust headers. This clearance, unavailable with conventional tools, makes it possible to apply force to handle 20 in order to apply torque about the axis of the spark plug for a sufficient degree of rotation to loosen or, as desired, tighten the threads of the spark plug in the cylinder head without removing the exhaust header or the engine from the vehicle engine compartment. Then, if further rotation is desired, again because of the unique construction of the present invention, hand tool 10 can be lifted slightly along the longitudinal axis of the spark plug without being limited by the occluding adjacent exhaust header, rotated back in the opposite direction, and then repositioned in secure engagement with the hexagonal spark plug base so that force can be applied again to rotate the spark plug in the desired direction. It should be noted that incorporating a ratcheting mechanism between handle 20 and tubular pass through socket 12 eliminates the need to lift and reposition hand tool 10 in order to obtain additional rotation about the longitudinal axis of the spark plug.

Turning next to FIG. 4, an alternative embodiment of the hand tool of the present invention and identified by reference numeral 110 is illustrated. Alternative embodiment hand tool 110 further exemplifies the unique aspects and features of the present invention. For purposes of clarity, elements of hand tool 110 that are essentially identical to similar elements in exemplary hand tool 10 are identified with the same reference numerals. Those elements of hand tool 110 that are illustrative of features and functions relevant to this particular exemplary embodiment of the present invention are identified with three digit reference numerals corresponding to the same or similar element of the previously discussed embodiment of the present invention preceded by the numeral 1. New or additional elements will be identified in successive numerical order without the preceding numeral 1.

Hand tool 110 is intended for use in connection with accessing and stably applying torque to one or more of the spark plugs in a Chevrolet big-block V8 engine. Though differing in size and exterior details from a small-block V8 engine, Chevrolet big-block V8 engines have the same problem with the exhaust headers occluding the spark plugs extending form the cylinder heads. However, because the angle of the spark plugs extending from the cylinder heads of a Chevrolet big-block V8 engine differs from those in a Chevrolet small-block V8 engine, the uniplanar angle between handle 20 and axis A of tubular pass through socket 12 is the compliment of angle X. In other words, angle Y in the alternative embodiment of hand tool 110 of the present invention ranges from approximately 55° to 60°. An illustrative exemplary angle Y is approximately 58°. In all other aspects the construction and features of hand tool 110 are identical to hand tool 10.

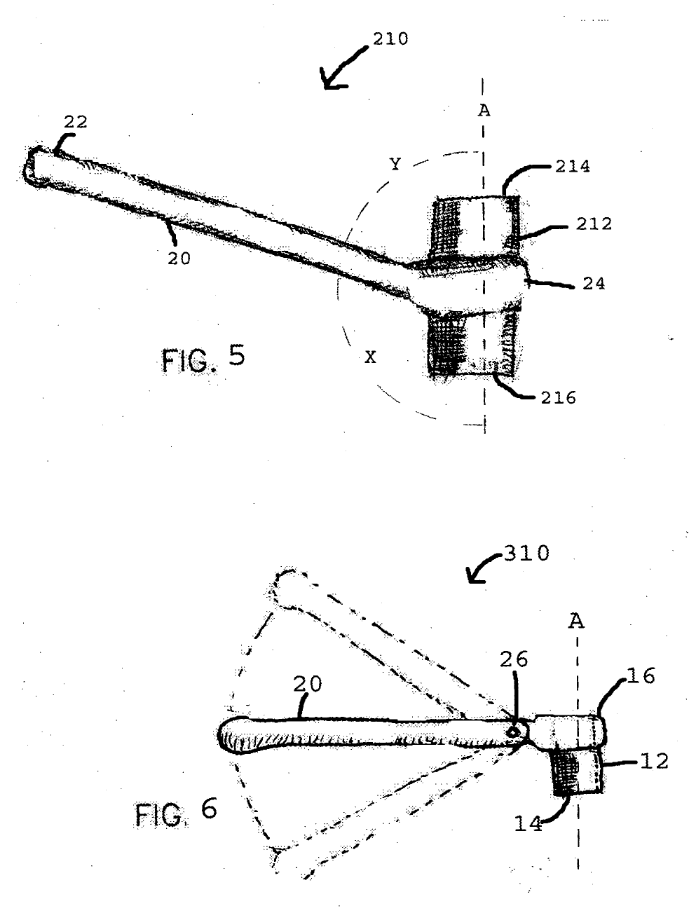

Turning next to FIG. 5, an additional alternative embodiment of the hand tool of the present invention is illustrated and identified by reference numeral 210. As with the previously discussed embodiments of the present invention, for purposes of clarity, elements of hand tool 210 that are essentially identical to similar elements in exemplary hand tools 10 and 110 are identified with the same reference numerals. Those elements of hand tool 210 that are illustrative of features and functions relevant to this particular exemplary embodiment of the present invention are identified with three digit reference numerals corresponding to the same or similar element of the previously discussed embodiments of the present invention preceded by the numeral 2. New or additional elements will be identified in successive numerical order without the preceding numeral 2.

Alternative embodiment hand tool 210 further exemplifies the unique aspects and features of the present invention. Hand tool 210 includes a tubular pass through socket 212 that is invertible or reversible and particularly well suited for use with either a Chevrolet small-block V8 or a Chevrolet big-block V8. Tubular pass through socket 212 is provided with opposing open ends 214 and 216. Depending upon the reversible orientation of hand tool 212 relative to a longitudinally or axially aligned spark plug (not shown), each open end 214 and 216 will allow a spark plug to pass into the cylindrical space defined by the interior of tubular pass through socket 212 as socket 212 is slipped into position over the spark plug. Tubular pass through socket 212 is provided with an internal surface (not shown) that is constructed to have appropriate dimensions to receive and engage the hexagonal base of a spark plug positioned within tubular pass through socket 212 at either of open ends 214 and 216. Thus, each of open ends 214 and 216 is provided with at least six, and preferably twelve facets or grooves and is sized to have a diameter appropriate to securely engage at least the apices of the hexagonal base of the spark plug. These diameters include 5/8 inch, 11/16 inch, and 13/16 inch, though other diameters are contemplated as being within the scope of the present invention.

In accordance with the teachings of the present invention, hand tool 210 also includes a handle 20 which radially extends from the side of tubular pass through socket 212. In FIG. 5 handle 20 is shown as being rigidly attached to tubular pass through socket 212. However, handle 20 may also be fixedly attached to tubular pass through socket 212 with a pivot. Again, handle 20 is formed to be of sufficient length to allow the average operator to apply a torque about axis A of tubular pass through socket 212 ranging from approximately 10 lbs/ft to 30 lbs/ft, or more.

Further, handle 20 is attached to tubular pass through socket 212 at a position 24 that is located essentially between opposing open ends 214 and 216, yet operates in the same manner as with the previously discussed embodiments of the present invention. Thus, handle 20 is securely fixed to tubular pass through socket 212 so that as handle 20 is pushed or pulled by a mechanic or tool operator it will apply a twisting force or torque about the longitudinal axis A of tubular pass through socket 212. When either of the reversible open ends 214 or 216 of tubular pass through socket 212 is securely engaged with the hexagonal base of a spark plug (not shown), longitudinal axis A will align with the longitudinal axis of the spark plug. Thus, torque applied in either direction to handle 20 and tubular pass through socket 212 attached thereto, will be stably applied about the longitudinal axis of a spark plug receivingly engaged in either open end 214 or open end 216.

Because handle 20 is attached to tubular pass through socket 212 at position 24, it is possible to flip hand tool 210 around handle 20 to select either open end 214 or open end 216 to position and slide over the extending end of a spark plug. Those skilled in the art will appreciate that regardless of which of the opposing open ends 214 or 216 is utilized handle 20 forms a uniplanar angle ranging from 50° to 130° relative to the longitudinal axis A of tubular pass through socket 212. Thus, if open end 214 is selected for use to receivingly engage a spark plug, handle 20 forms uniplanar angle Y relative to axis A and is well suited for use with a Chevrolet big-block V8 engine. Alternatively, if hand tool 210 is flipped over and open end 216 is used to receivingly engage a spark plug, handle 20 then forms uniplanar angle X relative to axis A and is well suited for use with a Chevrolet small-block V8 engine.

Those skilled in the art also will appreciate that even though the length of tubular pass through socket 212 may be longer than that of the tubular pass through sockets of the previously discussed embodiments of the present invention, in accordance with the teachings thereof, tubular pass through socket 212 has a length that is shorter than the combined length of the spark plug's porcelain insulator and hexagonal base longitudinally extending outwardly from the V8 engine cylinder head into which the spark plug is threaded.

Turning next to FIG. 6, a further additional exemplary embodiment of the present invention is illustrated and identified by reference numeral 310. As with the previous discussion of the present invention, for purposes of clarity, elements of alternative embodiment hand tool 310 that are essentially identical to similar elements in exemplary hand tools 10, 110, and 210 are identified with the same reference numerals. Those elements of hand tool 310 that are illustrative of features and functions that are relevant to this exemplary embodiment of the present invention are identified with three digit reference numerals corresponding to the same or similar element of the previously discussed embodiments of the present invention and preceded by the numeral 3. New or additional elements will be identified in successive numerical order without the preceding numeral 3.

Hand tool 310 includes a tubular pass through socket 12 with opposing open ends 14 and 16 and a longitudinal axis A. Handle 20 is fixedly engaged with tubular pass through socket 12 by a pivot 26 which allows handle 20 to form multiple uniplanar angles relative to axis A within the 50° to 130° range of the present invention. As a result, hand tool 310 is adaptable for use with Chevrolet small-block, big-block, and LS-1 V8 engines because pivot 26 allows a mechanic or operator of hand tool 310 to configure the angle between handle 20 and tubular pass through socket 12 to be appropriate for each of these V8 engines, as needed. For example, when it is desirable to remove or install one or more spark plugs in a Chevrolet small-block V8 engine, handle 20 can be pivoted to form angle X of approximately 120° to 125° relative to axis A of tubular pass through socket 12. Similarly, to remove or replace a spark plug in a Chevrolet big-block V8 engine the mechanic can pivot handle 20 to form angle Y of approximately 55° to 60°.

While it is contemplated as being within the scope of the present invention to allow handle 20 of hand tool 310 to freely swing about pivot 26 between the 50° to 130° uniplanar angle range disclosed by the present invention, providing pivot 26 with a positive indexing mechanism as known in the art is also within the scope and teachings of the present invention. For example a spring loaded ball and detent system can be provided in handle 20 with a spring loaded ball adjacent to pivot 26 located in handle 20 (not shown) and indexing detents (not shown) spaced at 58°, 90°, and 122° relative to axis A located in tubular pass through socket 12 adjacent to pivot 26. Such a positive indexing mechanism will engage and provide positive, indexing feedback to the mechanic or tool operator when a specific angle is produced. This and other alternative positive indexing mechanisms as known in the art are within the scope of the present invention.

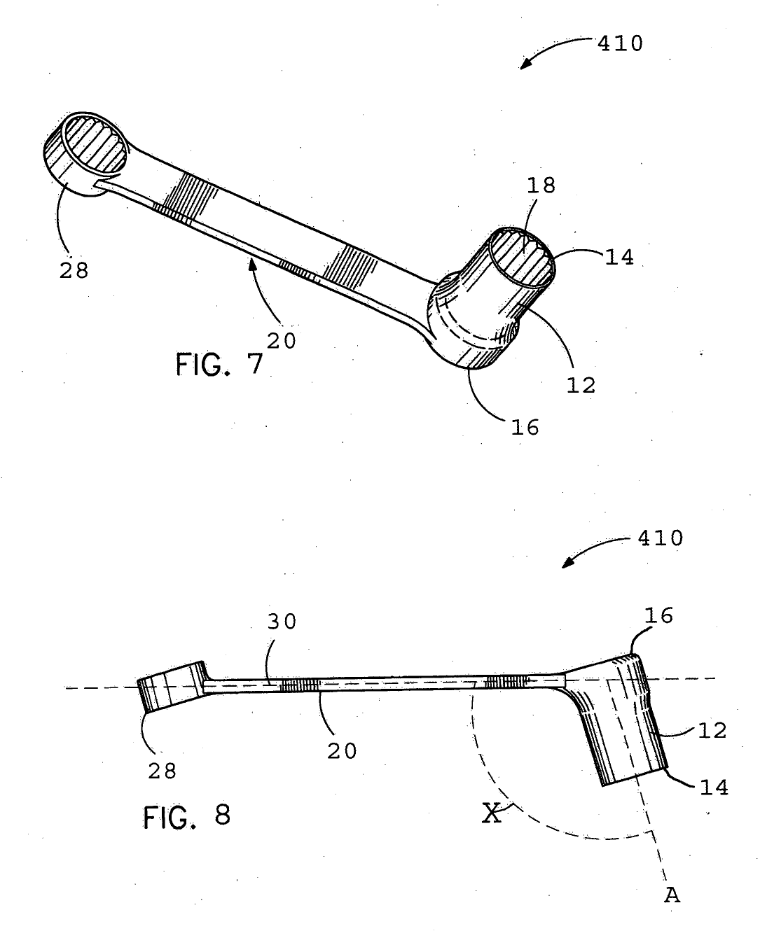

Referring now to FIGS. 7, 8, and 9, there is shown at reference numeral 410 an additional alternative embodiment of the present invention hand tool which is a combination box and socket wrench used to remove spark plugs from small-block Chevrolet V8 engines which have aftermarket headers. As with the previous discussion of the present invention, for purposes of clarity, elements of alternative embodiment hand tool 410 that are essentially identical to similar elements in exemplary hand tools 10, 110, 210, and 310 are identified with the same reference numerals. Those elements of hand tool 410 that are illustrative of features and functions that are relevant to this exemplary embodiment of the present invention are identified with three digit reference numerals corresponding to the same or similar element of the previously discussed embodiments of the present invention and preceded by the numeral 4. New or additional elements will be identified in successive numerical order without the preceding numeral 4.

The exemplary embodiment of the present invention illustrated by hand tool 410 again is of a perfect size and configuration to remove the spark plugs from Chevrolet small-block V8 engines without removing the headers. Again, by way of example, the type of engine with which the present invention hand tool 410 may be used is a small-block Chevrolet engine which can range from 283 cubic inches to 400 cubic inches. The concept is that the spark plugs are located in such an inaccessible area that the use of common tools or any combination of common tools is simply not workable and it takes an inordinate amount of time to remove the spark plugs from the small-block Chevrolet V8 engine, particularly with aftermarket headers, due to the cramped location of where the spark plugs are situated.

As with the embodiments of the present invention discussed with respect to FIGS. 1 through 3, hand tool 410 illustrated in FIGS. 7 through 9 comprises an elongated flat body forming handle 20 which has a tubular pass through socket 12. However, unlike the embodiment of the present invention discussed earlier, a shown in FIGS. 7 through 9, handle 20 of hand tool 410 is provided with a box end socket 28 in place of handle end 22. Box end socket 28 is integrally formed with handle 20 and tubular pass through socket 12. Tubular pass through socket 12 is provided with internal surface 18 which is of appropriate dimensions and configuration to securely engage at least the apices of the hexagonal base of a spark plug. Exemplary diameters of internal surface 18 include 5/8 inch, 11/16 inch, and 13/16 inch, though other diameters are contemplated as being within the scope of the present invention. Box end socket 28 may be of any size of configuration to fit other types of nuts, bolts, and fasteners. Box end socket 28 is illustrated as having a duodecimal or twelve-point configuration to fit conventional hexagonal nuts and bolts, though other configurations are within the scope of the present invention including those appropriate for Allen head bolts and Torx™ fasteners.

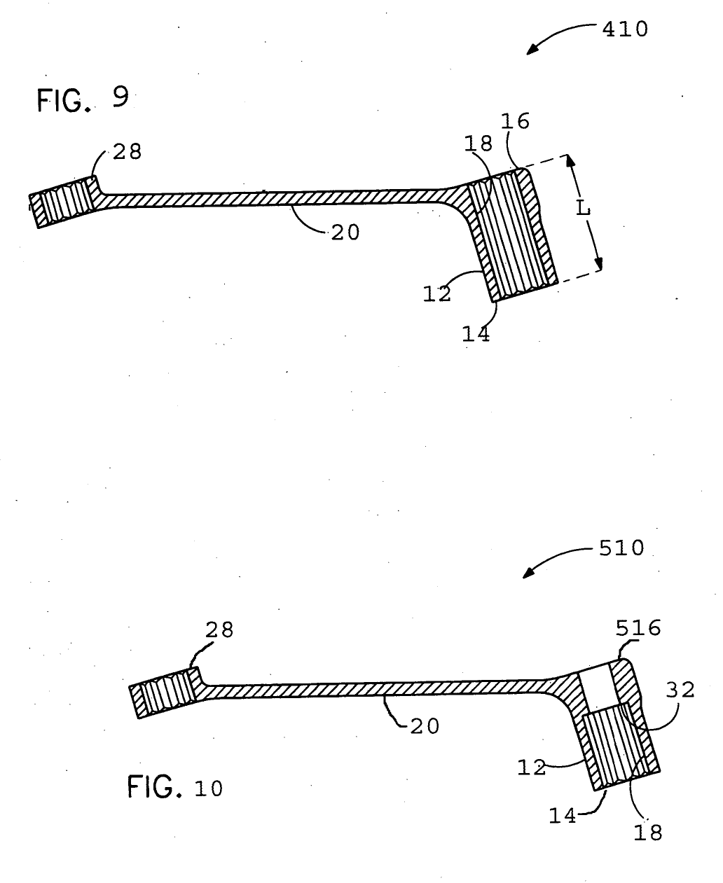

Referring to FIG. 9, the uniplanar orientation of the tubular pass through socket 12 relative to handle 20 has an angle X of approximately between the range of 120° to 125°, the angle X illustrated is 122° from the axial direction 30 of handle 20. It will be appreciated that the dimensions and the angle described above are merely one illustrative embodiment and can include many other comparable sets of dimensions and angles.

As with the previously discussed exemplary embodiments of the present invention, hand tool 410 conforms to conventional forms of manufacture or any other conventional way known to one skilled in the art, and is of simple construction and is easy to use. Further, as discussed above, hand tool 410 can be manufactured with or without the box end socket 28, as illustrated in FIGS. 1 through 3 where the hand tool basically has only tubular pass through socket 12 on one end. The other end of handle 20 can be a simple rounded handle end 22 as previously discussed, or can be flat for use as a pry bar, screw driver, or the like.

Referring next to FIG. 10, there is shown at reference numeral 510 an additional alternative embodiment of the present invention hand tool which is very similar to the preceding embodiments previously discussed. As with the previous discussion of the present invention, for purposes of clarity, elements of alternative embodiment hand tool 510 that are essentially identical to similar elements in exemplary hand tools 10, 110, 210, 310, and 410 are identified with the same reference numerals. Those similar elements of hand tool 510 that are illustrative of features and functions that are relevant to this exemplary embodiment of the present invention are identified with three digit reference numerals corresponding to the same or similar element of the previously discussed embodiments of the present invention and preceded by the numeral 5. New or additional elements will be identified in successive numerical order without the preceding numeral 5.

Hand tool 510 is illustrated with a rigidly attached handle 20 and is very similar to all the functions and features of the present invention previously discussed with respect to the other exemplary embodiments. A further additional feature of the present invention illustrated with respect to hand tool 510 is the alternative internal configuration of the tubular pass through socket 12. Instead of a relatively constant diameter internal surface 18 extending inwardly from open end 14, internal surface 18 extends for only a portion of the tubular pass through socket 12 and then forms a shoulder 32. Shoulder 32 is intended to abut the top of the hexagonal base of the spark plug receivingly engaged within open end 14 of tubular pass through socket 12. Thus, shoulder 32 adds an additional degree of stability and alignment of tubular pass through socket 12 about the spark plug.

Of course the present invention is not intended to be restricted to any particular form or arrangement, or any specific embodiment, or any specific use, disclosed herein, since the same may be modified in various particulars or relations without departing from the spirit or scope of the claimed invention. The various exemplary embodiments hereinabove shown and described are intended only for illustration and disclosure of operative embodiments and not to show all of the various forms or modifications in which this invention might be embodied or operated.

The present invention has been described in considerable detail in order to comply with the patent laws by providing full public disclosure of at least one of its forms. However, such detailed description is not intended in any way to limit the broad features or principles of the present invention, or the scope of the patent to be granted. Therefore, the invention is to be limited only by the scope of the appended claims.

What is claimed is:

1. A hand tool for accessing and stably applying torque about the longitudinal axis of at least one spark plug having a hexagonal base threaded into and longitudinally extending from a cylinder head of a Chevrolet V8 engine in an vehicle engine compartment, and a porcelain insulator longitudinally extending outwardly from said hexagonal base and said cylinder head, said porcelain insulator occluded by an adjacent exhaust header mounted to said cylinder head, without removing said adjacent exhaust header, said hand tool comprising:
a tubular pass through socket having both ends open, a length greater than the length of said extending hexagonal base and shorter than the combined length of said porcelain insulator and said hexagonal base extending from said engine, and an internal surface disposed adjacent to at least one of said open ends and dimensioned to receivingly engage at least the apices of said hexagonal base in secure, alignment with said longitudinal axis; and
a handle fixedly engaged with and radially extending from said tubular pass through socket and forming a uniplanar angle ranging from approximately 50° to 130° relative to said longitudinal axis of said spark plug.

2. The hand tool of claim 1, wherein said handle is rigidly attached to said tubular pass through socket.

3. The hand tool of claim 1, wherein said handle is pivotally attached to said tubular pass through socket.

4. The hand tool of claim 1, wherein said internal surface of said tubular pass through socket is hexagonal.

5. The hand tool of claim 1, wherein said internal surface of said tubular pass through socket is duodecimal.

6. The hand tool of claim 1, wherein said handle is of sufficient length to apply a torque about the longitudinal axis of said spark plug ranging from approximately 10 lbs/ft to 30 lbs/ft.

7. The hand tool of claim 1 further comprising a ratcheting mechanism operationally disposed between said tubular pass through socket and said handle.

8. The hand tool of claim 1, wherein said handle is between five and seven inches long.

9. The hand tool of claim 1, wherein said length of said tubular pass through socket ranges from approximately 1 inch to 1½ inch.

10. The hand tool of claim 1, wherein said internal surface of said tubular pass through socket has a diameter selected from the group consisting of 5/8 inch, 11/16 inch, and 13/16 inch.

11. A hand tool for accessing and stably applying torque about the longitudinal axis of at least one spark plug having a hexagonal base threaded into and longitudinally extending from a cylinder head of a Chevrolet V8 engine in a vehicle engine compartment, and a porcelain insulator longitudinally extending outwardly from said hexagonal base and said cylinder head, said porcelain insulator occluded by an adjacent exhaust header mounted to said cylinder head, without removing said adjacent exhaust header, said hand tool comprising:
a tubular pass through socket having both ends open and a length greater than the length of said extending hexagonal base and shorter than the combined length of said porcelain insulator and said hexagonal base extending from said engine, and a duodecimal internal surface disposed adjacent to one of said open ends and dimensioned to receivingly engage at least the apices of said hexagonal base in secure, alignment with said longitudinal axis; and
a rigid handle fixedly engaged with and radially extending from a position generally adjacent to the other of said open ends of said tubular pass through socket and forming a uniplanar angle ranging from approximately 50° to 130° relative to said longitudinal axis of said spark plug.

12. The hand tool of claim 11, wherein said rigid handle is of sufficient length to apply a torque about the longitudinal axis of said spark plug ranging from approximately 10 lbs/ft to 30 lbs/ft.

13. The hand tool of claim 11 further comprising a ratcheting mechanism operationally disposed between said tubular pass through socket and said rigid handle.

14. The hand tool of claim 11, wherein said rigid handle is between five and seven inches long.

15. The hand tool of claim 11, wherein said length of said tubular pass through socket ranges from approximately 1 inch to 1½ inch.

16. The hand tool of claim 11, wherein said internal surface of said tubular pass through socket has a diameter selected from the group consisting of 5/8 inch, 11/16 inch, and 13/16 inch.

17. A hand tool for accessing and stably applying torque about the longitudinal axis of at least one spark plug having a hexagonal base threaded into and longitudinally extending from a cylinder head of a Chevrolet V8 engine in a vehicle engine compartment, and a porcelain insulator longitudinally extending outwardly from said hexagonal base and said cylinder head, said porcelain insulator occluded by an adjacent exhaust header mounted to said cylinder head, without removing said adjacent exhaust header, said hand tool comprising:
a tubular pass through socket having both ends open and a length greater than the length of said extending hexagonal base and shorter than the combined length of said porcelain insulator and said hexagonal base extending from said engine, and a duodecimal internal surface disposed adjacent to each of said open ends and dimensioned to receivingly engage at least the apices of said hexagonal base in secure, alignment with said longitudinal axis; and
a handle fixedly engaged with and radially extending from said tubular pass through socket at a position generally equidistant from each of said open ends and forming a uniplanar angle ranging from approximately 50° to 130° relative to said longitudinal axis of said spark plug.

18. The hand tool of claim 17, wherein said handle is rigidly attached to said tubular pass through socket.

19. The hand tool of claim 17, wherein said handle is pivotally attached to said tubular pass through socket.

20. The hand tool of claim 17, wherein said handle is of sufficient length to apply a torque about the longitudinal axis of said spark plug ranging from approximately 10 lbs/ft to 30 lbs/ft.

21. The hand tool of claim 17 further comprising a ratcheting mechanism operationally disposed between said tubular pass through socket and said handle.

22. The hand tool of claim 17, wherein said handle is between five and seven inches long.

23. The hand tool of claim 17, wherein said length of said tubular pass through socket ranges from approximately 1 inch to 1½ inch.

24. The hand tool of claim 17, wherein said internal surface of said tubular pass through socket has a diameter selected from the group consisting of 5/8 inch, 11/16 inch, and 13/16 inch.
